(19) United States
(12) Patent Application Publication
(10) Pub. No.: US 2024/0230133 A1
(43) Pub. Date: Jul. 11, 2024

(54) REMOTE MONITORING APPARATUS OF AIR CONDITIONER AND AIR CONDITIONING SYSTEM

(71) Applicant: Mitsubishi Electric Corporation, Tokyo (JP)

(72) Inventors: Shuichiro SENDA, Tokyo (JP); Tomoo NAKANO, Tokyo (JP)

(21) Appl. No.: 18/570,771

(22) PCT Filed: Aug. 6, 2021
(86) PCT No.: PCT/JP2021/029348

§ 371 Date: Dec. 15, 2023

(51) Int. Cl. F24F 11/58; F24F 11/30

(52) U.S. Cl. CPC F24F 11/58; F24F 11/30

(57) ABSTRACT

A remote monitoring apparatus includes a processor and a flash memory. By executing an FW at a time of activation, processor connects to a server via a network and determines whether FW coincides with or does not coincide with a latest program stored in the server based on a version information, and continues executing FW when FW coincides with the latest program, and acquires the latest program from server and executes a program update process of replacing FW with the latest program when FW does not coincide with the latest program.

### CROSS-REFERENCE TO RELATED APPLICATION

This application is a U.S. National Stage Application of PCT/JP2021/029348 filed on Aug. 6, 2021, the contents of which are incorporated herein by reference.

### TECHNICAL FIELD

The present disclosure relates to a remote monitoring apparatus of air conditioner and an air conditioning system.

### BACKGROUND

In a large-scale air conditioner, a control program may be distributed from a network server. For example, Japanese Patent No. 6141242 (PTL 1) discloses a control program distribution system that distributes a control program from a server to an indoor unit and an outdoor unit of an air conditioner via a network and a relay device (edge device).

### PATENT LITERATURE

PTL 1: Japanese Patent No. 6141242

The control program distribution system disclosed in Japanese Patent No. 6141242 (PTL 1) distributes a control program from a server via a relay device immediately after installation work of an air conditioner is completed in order to conceal the control program and reduce a risk of unauthorized use of the control program.

On the other hand, in addition to the distribution of the control program of the air conditioner, the network may be used to remotely monitor or remotely control the air conditioner. In this case, the relay device also acts as a remote monitoring apparatus. A control program (hereinafter also referred to as firmware or FW) of a remote monitoring apparatus and an air conditioner may be subjected to a version upgrade for the purpose of improvement in multifunctionality, controllability, or the like. In order to reliably apply the version upgrade of the control program after the remote monitoring apparatus and the air conditioner start to operate, there is room for improvement in the relay device used in the control program distribution system.

### SUMMARY

The present disclosure has been made to solve the above-described problem, and an object of the present disclosure is to provide a remote monitoring apparatus of an air conditioner capable of maintaining a version of a control program to be a latest regular program.

The present disclosure relates to a remote monitoring apparatus of an air conditioning system for remotely monitoring or remotely operating the air conditioning system. The remote monitoring apparatus includes: a processor; and a nonvolatile memory to store a first program for remotely monitoring or remotely operating the air conditioning system and a version information of the first program. By executing the first program at the time of activation, the processor: (a) connects to a server via a network and determines whether the first program coincides with or does not coincide with a latest program stored in the server based on the version information; and (b) continues executing the first program when the first program coincides with the latest program, and acquires the latest program from the server and executes a program update process of replacing the first program with the latest program when the first program does not coincide with the latest program.

According to the remote monitoring apparatus of the present disclosure, it is possible to maintain the control program to be in the regular latest version without the user or the administrator being aware of the matter.

### BRIEF DESCRIPTION OF DRAWINGS

FIG. 1 is a diagram showing an overall configuration of an air conditioning system 1 according to Embodiment 1.

FIG. 2 is a block diagram showing a configuration of a remote monitoring apparatus and a server according to Embodiment 1.

FIG. 3 is a flowchart for illustrating a process executed in a remote monitoring apparatus 21.

FIG. 4 is a block diagram showing a configuration of a remote monitoring apparatus and a server according to Embodiment 2.

FIG. 5 is a flowchart for illustrating a process executed in a remote monitoring apparatus 21A.

### DETAILED DESCRIPTION

Hereinafter, embodiments of the present disclosure will be described in detail with reference to the drawings. Although a plurality of embodiments will be described below, it is planned from the beginning of the application that the configurations described in the embodiments are appropriately combined. Note that the same or corresponding parts in the drawings are denoted by the same reference signs, and description thereof will not be repeated.

### Embodiment 1

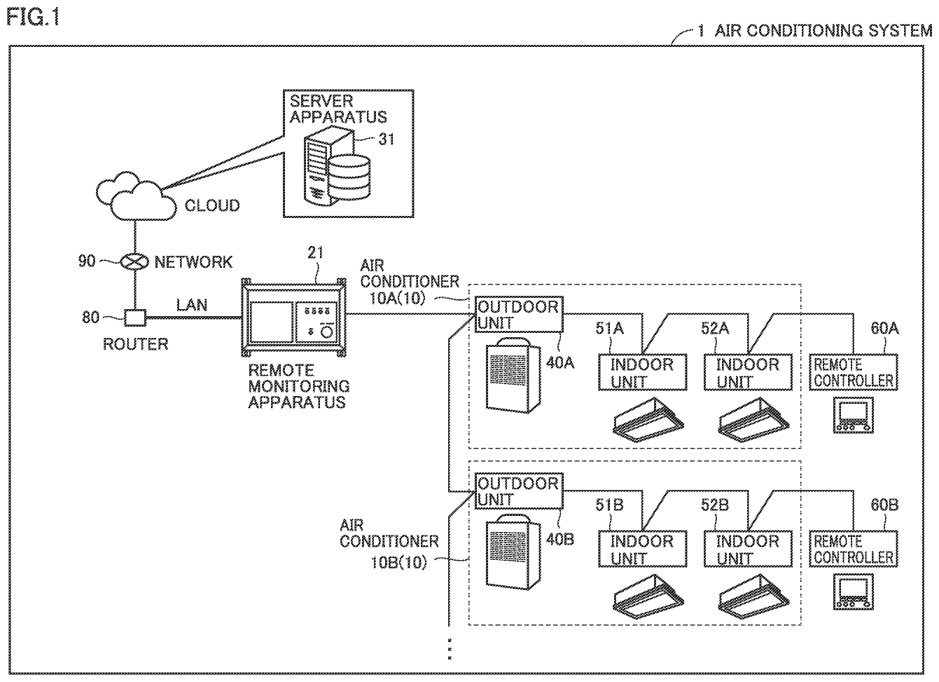

FIG. 1 is a diagram showing an overall configuration of an air conditioning system 1 according to Embodiment 1. As shown in FIG. 1, air conditioning system 1 includes an air conditioner 10, a remote monitoring apparatus 21, and a server apparatus 31.

Remote monitoring apparatus 21 is communicably connected to at least one air conditioner 10. For example, air conditioner 10 includes an air conditioner 10A and an air conditioner 10B, and remote monitoring apparatus 21 is communicably connected to each of air conditioner 10A and air conditioner 10B. Air conditioner 10A includes an outdoor unit 40A, an indoor unit 51A, and an indoor unit 52A, and is communicably connected to a remote controller 60A. Air conditioner 10A configured as described above adjusts temperature, humidity, or the like of air sucked from an indoor space based on an operation of remote controller 60A, and supplies adjusted air to the indoor space. Air conditioner 10B includes an outdoor unit 40B, an indoor unit 51B, and an indoor unit 52B, and is communicably connected to a remote controller 60B. Air conditioner 10B configured as described above adjusts temperature, humidity, or the like of air sucked from the indoor space based on an operation of remote controller 60B, and supplies adjusted air to the indoor space.

Remote monitoring apparatus 21, monitors air conditioner 10, and for example, collects air-conditioning data related to air-conditioning of air conditioner 10, and controls air conditioner 10. That is, remote monitoring apparatus 21 performs remote monitoring and remote operation. As the remote monitoring, remote monitoring apparatus 21 collects the air-conditioning data and uploads the data to a cloud server in a wireless or wired manner. Further, as the remote operation, remote monitoring apparatus 21 receives an instruction from the cloud server to change settings such as an operation mode, a temperature, and a wind direction of the air conditioner.

Server apparatus 31 exists between remote monitoring apparatus 21 and a user device 70 in a cloud computing mode. Remote monitoring apparatus 21 is connected to a router 80 via a LAN (Local Area Network). Server apparatus 31 is communicably connected to router 80 via a network 90.

Server apparatus 31 accumulates and stores the air-conditioning data of air conditioner 10 collected by remote monitoring apparatus 21. The air-conditioning data includes, for example, data such as an operation state corresponding to operation or stop, an operation start time, an operation end time, a set temperature, a set humidity, an operation mode of cooling/heating, an indoor temperature, and an indoor humidity. The air-conditioning data may include data such as a refrigerant temperature and a refrigerant pressure measured by a sensor installed in a refrigerant pipe or the like.

Further, server apparatus 31 outputs data corresponding to various setting values input using the user device to remote monitoring apparatus 21. Remote monitoring apparatus 21 controls air conditioner 10 based on the data acquired from server apparatus 31.

Communication between server apparatus 31 and remote monitoring apparatus 21 is performed in accordance with a communication standard A. As communication standard A, for example, on the Internet, connection by TCP/IP (Transmission Control Protocol/Internet Protocol) which is a general communication method is assumed. TCP/IP is a standard set of communication protocols used in many computer networks, including the Internet.

Communication between remote monitoring apparatus 21 and air conditioner 10 is performed in accordance with a communication standard B. Communication standard B is, for example, bus communication unique to a manufacturer. Although not particularly limited, the communication speed of communication standard B is often lower than that of communication standard A.

A storage device for storing an update program of air conditioner 10 such as a firmware to be updated is disposed in remote monitoring apparatus 21, and the storage device may be provided in an outdoor unit, an indoor unit, a remote controller, or the like of air conditioner 10. However, since the communication network among the outdoor unit, the indoor unit, and the remote controller has a low communication speed, when data is requested, it takes time for the data to arrive from server apparatus 31. For this reason, it is desirable that a storage device for downloading an FW from server apparatus 31 is provided inside remote monitoring apparatus 21 capable of communicating with server apparatus 31 via a wired LAN, a wireless LAN, or the like.

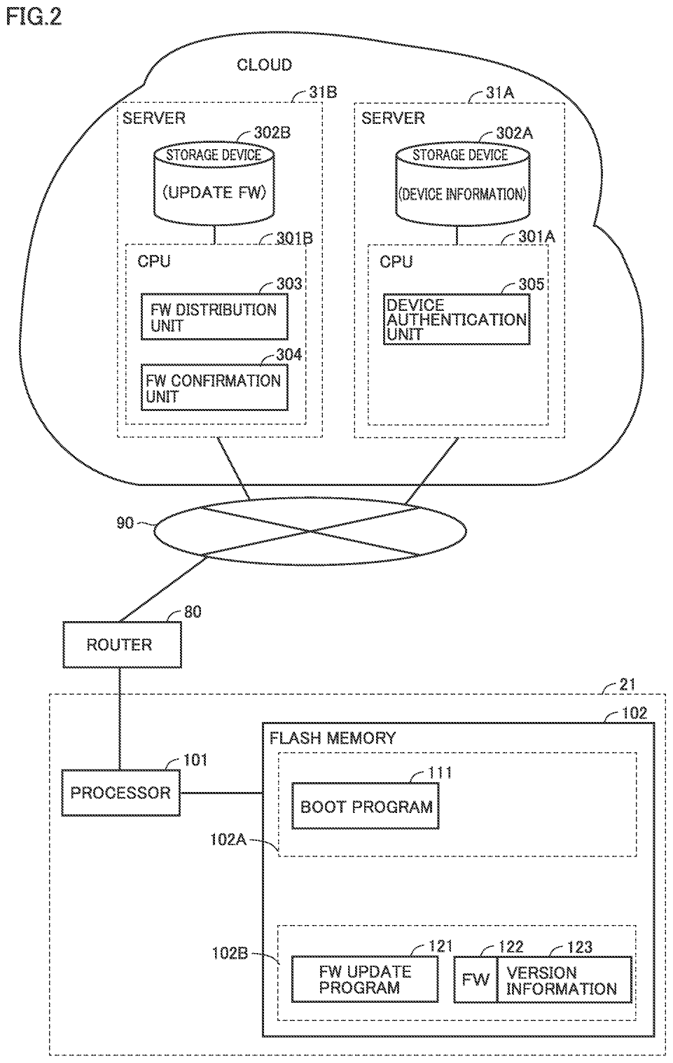

FIG. 2 is a block diagram showing a configuration of the remote monitoring apparatus and the server according to Embodiment 1. Server apparatus 31 represented as a cloud shown in FIG. 2 includes a server 31A and a server 31B.

Server 31A includes a CPU (Central Processing Unit) 301A and a storage device 302A. Storage device 302A stores device information of remote monitoring apparatus 21. CPU 301A operates as a device authentication unit 305 by executing a program. Device authentication unit 305 determines a connectable device, and permits connection to server 31B when the connectable device is determined.

Server 31B includes a CPU 301B and a storage device 302B. Storage device 302B stores the FW for update. CPU 301B operates as an FW confirmation unit 304 and an FW distribution unit 303 by executing a program. FW confirmation unit 304 determines whether or not the FW to be updated exists in a storage device 302B. When the FW to be updated is confirmed, the FW distribution unit distributes an update FW to remote monitoring apparatus 21. After confirming the update FW by FW confirmation unit 304, server 31B distributes the update FW to remote monitoring apparatus 21 by FW distribution unit 303.

Each of storage devices 302A and 302B includes various semi-conductor memory devices, hard disks, and the like.

Remote monitoring apparatus 21 includes a processor 101 and a flash memory 102. Processor 101 operates as various processing units by executing various programs stored in flash memory 102.

Processor 101 loads programs stored in flash memory 102 into a RAM (Random Access Memory) or the like and executes the programs. The programs stored in flash memory 102 are programs that describe the processing procedure for operating as remote monitoring apparatus 21. Processor 101 executes a boot process, an FW update process, and the like in accordance with these programs. Processor 101 that executes these processes may be a single CPU or may be a plurality of different CPUs.

Flash memory 102 includes a protected area 102A which is prohibited from being rewritten and a rewritable area 102B which is set to be rewritable.

A boot program 111 is stored in protected area 102A. An FW update program 121, an FW 122, and a version information 123 are stored in rewritable area 102B.

FW 122 and version information 123 are data of the FW currently being executed by remote monitoring apparatus 21 and data showing the FW version.

FW update program 121 inquires server 31B in the cloud and checks version information 123 to confirm whether or not there is an update FW newer than FW 122 currently stored in rewritable area 102B at the time of activation of remote monitoring apparatus 21. When there is an update FW of a newer version than the currently held FW, FW update program 121 downloads the update FW from server 31B and rewrites FW 122 and version information 123.

At the time of activation of remote monitoring apparatus 21, boot program 111 is executed to load FW 122 into the RAM or the like and execute FW 122.

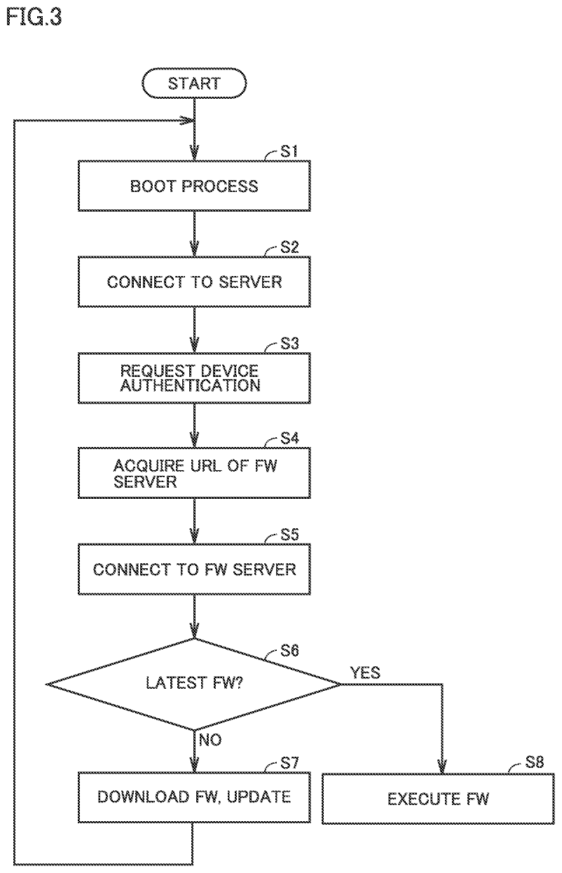

FIG. 3 is a flowchart for illustrating a process executed by remote monitoring apparatus 21. When remote monitoring apparatus 21 is powered on, processor 101 executes the boot process by boot program 111 in step S1. Thus, FW 122 stored in flash memory 102 becomes executable, and the processes from step S2 are executed according to FW 122.

First, in step S2, remote monitoring apparatus 21 is connected to server 31A via router 80. Then, in step S3, remote monitoring apparatus 21 requests server 31A to perform device authentication. Server 31A determines whether or not the device information registered in storage device 302A coincides with the device information of remote monitoring apparatus 21. When the device authentication is normally performed in step S3, remote monitoring apparatus 21 is permitted to connect to server 31B. Then, in step S4, remote monitoring apparatus 21 can acquire a URL of server 31B storing the update FW from server 31A.

In step S5, remote monitoring apparatus 21 connects to server 31B by using the acquired URL. Subsequently, in step S6, processor 101 refers to version information 123 of FW 122 stored in flash memory 102 to determine whether or not the latest FW held by server 31B coincides with FW 122.

When FW 122 coincides with the latest FW (YES in S6), FW 122 is directly executed in step S8. On the other hand, when FW 122 does not coincide with the latest FW (NO in S6), in step S7, processor 101 downloads the latest FW from server 31B and executes FW update program 121. When the replacement of FW 122 with the latest FW is completed by the update, remote monitoring apparatus 21 is then restarted, and the processes from step S1 are executed again.

As described above, in Embodiment 1, when there is no special update instruction from a user, if the updated FW is registered in server apparatus 31, remote monitoring apparatus 21 can always execute the latest regular FW.

### Embodiment 2

There is a possibility that an unauthorized FW is written in the remote monitoring apparatus or the server by a malicious third party. A technique called secure boot for preventing such unauthorized FW from being executed is known. In Embodiment 2, the secure boot is also applied to a remote monitoring apparatus of an air conditioner. The secure boot is a technique in which a software is verified using a key data and a digital signature given to the software in advance at the time of activation so that only regular software can be executed.

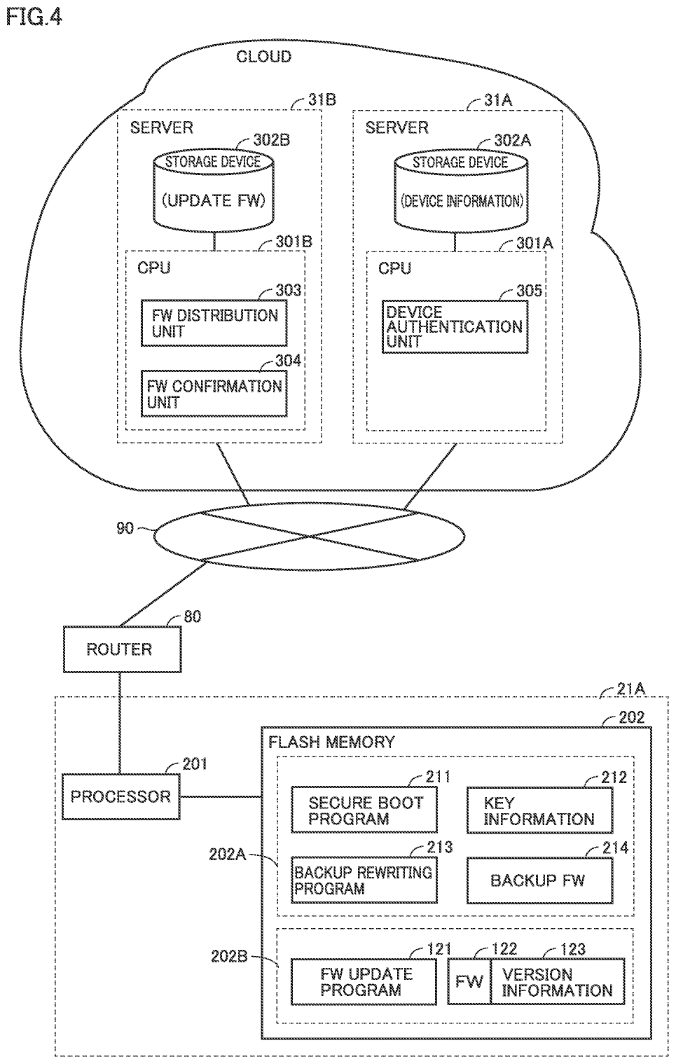

FIG. 4 is a block diagram showing a configuration of the remote monitoring apparatus and the server according to Embodiment 2.

Server apparatus 31 represented as a cloud shown in FIG. 4 includes server 31A and server 31B.

Since server 31A and server 31B have the same configurations as those in Embodiment 1, description thereof will not be repeated here.

A remote monitoring apparatus 21A includes a processor 201 and a flash memory 202. Processor 201 operates as various processing units by executing various programs stored in flash memory 202.

Flash memory 202 includes a protected area 202A which is prohibited from being rewritten and a rewritable area 202B which is set to be rewritable.

A secure boot program 211, a key information 212, a backup rewriting program 213, and a backup FW 214 are stored in protected area 202A.

FW update program 121, FW 122, and version information 123 are stored in rewritable area 202B.

FW 122 and version information 123 are data of the FW currently being executed by remote monitoring apparatus 21A and data showing the FW version.

FW update program 121 inquires server 31B in the cloud and checks version information 123 to confirm whether or not there is an update FW newer than FW 122 currently stored in rewritable area 202B at the time of activation of remote monitoring apparatus 21A. When there is an update FW of a newer version than the currently held FW, FW update program 121 downloads the update FW from server 31B and rewrites FW 122 and version information 123 into the latest FW and the version information thereof.

Key information 212 is key data for verification used by secure boot program 211. In Embodiment 2, a regular digital signature is attached to regular FW 122, and secure boot program 211 verifies whether or not the digital signature is regular using key information 212. In this way, secure boot program 211 verifies whether or not the FW has been tampered with using key information 212.

Backup FW 214 is a FW data for backup used in place of FW 122 when secure boot program 211 fails in verification.

Backup rewriting program 213 is executed when secure boot program 211 fails in verification, and rewrites FW 122 and version information 123 into backup FW 214 and an initial version information, respectively.

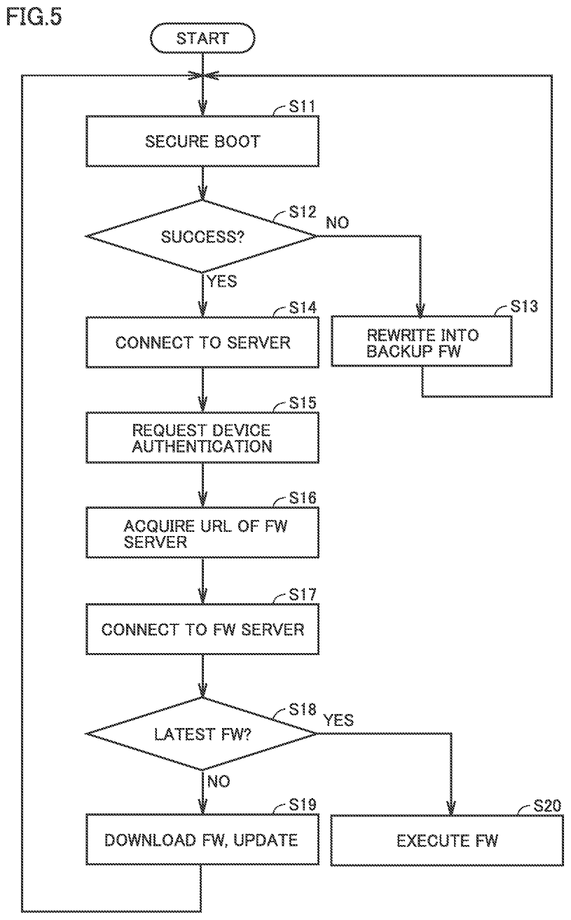

FIG. 5 is a flowchart for illustrating a process executed in remote monitoring apparatus 21A. When remote monitoring apparatus 21A is powered on, processor 201 executes secure boot program 211 in step S11. Secure boot program 211 uses key information 212 to verify whether or not FW 122 currently stored in flash memory 202 has been tampered with.

In step S12, processor 201 determines whether or not the secure boot has succeeded. When it is determined that FW 122 has not been tampered with, the secure boot has succeeded, and when it is determined that FW 122 has been tampered with, the secure boot has failed.

When the secure boot has succeeded (YES in S12), the process of step S14 is executed. On the other hand, when the secure boot has failed (NO in S12), the process of step S13 is executed.

In step S13, processor 201 executes backup rewriting program 213. Backup rewriting program 213 rewrites FW 122 into backup FW 214. When the rewriting is completed, remote monitoring apparatus 21A is restarted by itself, and the secure boot in step S11 is executed again. Backup FW 214 is written in protected area 202A in advance, and it is guaranteed that the secure boot succeeds. Therefore, in this case, the secure boot succeeds in step S12, and the process of step S14 is executed.

From step S14, processor 201 executes FW 122. First, in step S14, remote monitoring apparatus 21A is connected to server 31A via router 80. Then, in step S15, remote monitoring apparatus 21A requests server 31A to perform device authentication. Server 31A determines whether or not the device information registered in storage device 302A coincides with the device information of remote monitoring apparatus 21A. When the device authentication is normally performed in step S15, remote monitoring apparatus 21A is permitted to connect to server 31B. Then, in step S16, remote monitoring apparatus 21A can acquire the URL of server 31B storing the update FW from server 31A.

In step S17, remote monitoring apparatus 21A connects to server 31B by using the acquired URL. Subsequently, in step S18, processor 201 refers to version information 123 of FW 122 stored in flash memory 202 to determine whether or not the latest FW held by server 31B coincides with FW 122.

When FW 122 coincides with the latest FW (YES in S18), FW 122 is directly executed in step S20. On the other hand, when FW 122 does not coincide with the latest FW (NO in S18), in step S19, processor 201 downloads the latest FW from server 31B and executes FW update program 121. When the update is completed, remote monitoring apparatus 21A is then restarted, and the processes from step S11 are executed again.

Since it is clear that the FW has become the latest after the restart, when there is a history of restart, the processes of steps S16 to S18 may be omitted.

As described above, in Embodiment 2, in addition to the effects obtained in Embodiment 1, when FW 122 has been tampered with for some reason, the FW which has been tampered with can be eliminated and the latest regular FW can be executed.

The protected area and the rewritable area are provided in flash memories 102, 202 in Embodiments 1, 2, and these areas can be easily realized by a flash memory capable of applying protection for each sector. It is possible to determine whether each sector is set to the protected area or the rewritable area by setting a lock bit for each sector when manufacturing the remote monitoring apparatus. In addition, an area requiring a password for rewriting may be set as the protected area. Alternatively, the protected area and the rewritable area may be formed as different chips, respectively.

### SUMMARY

The present disclosure relates to remote monitoring apparatus 21 of an air conditioner for remotely monitoring or remotely operating air conditioner 10. Remote monitoring apparatus 21 includes: processor 101; and flash memory 102 for storing a first program (FW 122) for remotely monitoring or remotely operating air conditioner 10 and version information 123 of the first program (FW 122). By executing the first program (FW 122) at the time of activation, processor 101: (a) connects to server 31B via network 90 and determines whether the first program (FW 122) coincides with or does not coincide with the latest program stored in the server based on the version information; and (b) continues executing the first program (FW 122) when the first program (FW 122) coincides with the latest program, and acquires the latest program from server 31B and executes a program update process of replacing the first program (FW 122) with the latest program when the first program (FW 122) does not coincide with the latest program.

With such a configuration, when there is no special update instruction from a user, if the updated FW is registered in server apparatus 31, remote monitoring apparatus 21 can always execute the latest regular FW.

Preferably, as shown in FIG. 4, in addition to the first program (FW 122), flash memory 202 stores a second program (secure boot program 211) for executing a verification process for verifying whether or not the first program (FW 122) is a regular program, and a backup program (backup FW 214) for executing at least the program update process. As a result of verification by the second program (secure boot program 211) at the time of activation, processor 201 executes the first program (FW 122) when the first program (FW 122) is a regular program, and executes the backup program (backup FW 214) in place of the first program (FW 122) when the first program (FW 122) is not a regular program.

With such a configuration, when FW 122 has been tampered with for some reason, the FW which has been tampered with can be eliminated and the latest regular FW can be executed.

More preferably, flash memory 202 stores key information 212 used by the second program (secure boot program 211). Flash memory 202 is configured such that a partial area thereof can be set to be protected area 202A where data cannot be rewritten. The second program (secure boot program 211), key information 212, and the backup program (backup FW 214) are stored in protected area 202A. The first program (FW 122) and version information 123 are stored in an area (rewritable area 202B) different from protected area 202A of flash memory 202.

Preferably, the first program (FW 122) is signed with the digital signature. By executing the second program (secure boot program 211), processor 201 verifies whether or not the digital signature is regular using key information 212 in the verification process.

With such a configuration, there is no possibility that secure boot program 211, backup FW 214, and backup rewriting program 213 are tampered with, and thus, even when FW 122 has been tampered with, by replacing FW 122 with backup FW 214, replacing version information 123 with the initial version, and acquiring the latest program from the server again to perform the program update process, it is possible to reliably eliminate the tampered FW and execute the latest regular FW.

Preferably, server apparatus 31 includes server 31A for authenticating the remote monitoring apparatus and server 31B for holding the latest program. As shown in FIG. 5, a processor 201 requests server 31A to perform authentication (S15), and acquires information (URL), which is for accessing server 31B, from server 31A when the device information of remote monitoring apparatus 21A coincides with the device information stored in server 31A (S16).

Preferably, as shown in step S7 of FIG. 3 or step S19 of FIG. 5, when processor 201 executes the program update process, processor 201 restarts and executes the first program (FW 122) which has been replaced with the latest program.

Although an example in which a storage device is provided in remote monitoring apparatus 21 has been described in the embodiment disclosed herein, a storage device that stores an update program of air conditioner 10 such as a firmware may be provided in an outdoor unit, an indoor unit, a remote controller, or the like of air conditioner 10, and the technique described in the present embodiment may be applied to the FW update of air conditioner 10.

It should be understood that the embodiments disclosed herein are illustrative in all respects and are not restrictive. The scope of the present disclosure is defined not by the above description of the embodiments but by the claims, and is intended to include all modifications within the meaning and scope equivalent to the claims.

1. A remote monitoring apparatus of an air conditioner for remotely monitoring or remotely operating an air conditioner, the remote monitoring apparatus comprising:
a processor; and
a nonvolatile memory to store a first program for remotely monitoring or remotely operating the air conditioner and a version information of the first program, wherein
the processor executes the first program at a time of activation to:
(a) connect to a server via a network and determine whether the first program coincides with or does not coincide with a latest program stored in the server based on the version information; and
(b) continue executing the first program when the first program coincides with the latest program, and acquire the latest program from the server and execute a program update process of replacing the first program with the latest program when the first program does not coincide with the latest program,
the nonvolatile memory stores, separately from the first program, a second program to execute a verification process for verifying whether or not the first program is a regular program, and a backup program to execute at least the program update process,
as a result of verification by the second program at the time of activation, the processor executes the first program when the first program is a regular program, and executes the backup program in place of the first program when the first program is not a regular program,
the nonvolatile memory is configured such that a partial area thereof can be set to be a protected area where a data cannot be rewritten, and
the backup program is stored in the protected area.

2. (canceled)

3. The remote monitoring apparatus according to claim 1,
wherein
the nonvolatile memory further stores a key information used by the second program,
in addition to the backup program, the second program, and the key information are stored in the protected area, and
the first program and the version information are stored in an area different from the protected area of the nonvolatile memory.

4. The remote monitoring apparatus according to claim 3, wherein
the first program is signed with a digital signature, and
the processor verifies whether or not the digital signature is regular using the key information in the verification process by executing the second program.

5. The remote monitoring apparatus according to claim 1, wherein
the server includes:
a first server to authenticate the remote monitoring apparatus; and
a second server to hold the latest program, and
the processor requests the first server to perform authentication, and acquires from the first server an information for accessing the second server when a device information of the remote monitoring apparatus coincides with a device information stored in the first server.

6. The remote monitoring apparatus according to claim 1, wherein when the processor executes the program update process, the processor restarts and executes the first program which has been replaced with the latest program.

7. An air conditioning system comprising:
the remote monitoring apparatus according to claim 1,
the air conditioner; and
the server.

8. An air conditioning system comprising:
the remote monitoring apparatus according to claim 3,
the air conditioner; and
the server.

9. An air conditioning system comprising:
the remote monitoring apparatus according to claim 4,
the air conditioner; and
the server.

10. An air conditioning system comprising:
the remote monitoring apparatus according to claim 5,
the air conditioner; and
the server.

11. An air conditioning system comprising:
the remote monitoring apparatus according to claim 6,
the air conditioner; and
the server.
